(19) United States
(12) Patent Application Publication
(10) Pub. No.: US 2013/0246409 A1
(43) Pub. Date: Sep. 19, 2013

(54) TOPOGRAPHY BY POPULARITY

(71) Applicants: Hanan Polansky, Carmei-Yosef, NY (US); Ami Gur, Ganei-Tiqva (IL); Boaz Shnapp, Herzeliya (IL); Boris Yevsikov, Ramat Hasharon (IL)

(72) Inventors: Hanan Polansky, Carmei-Yosef, NY (US); Ami Gur, Ganei-Tiqva (IL); Boaz Shnapp, Herzeliya (IL); Boris Yevsikov, Ramat Hasharon (IL)

(21) Appl. No.: 13/562,402

(22) Filed: Jul. 31, 2012

Related U.S. Application Data
(60) Provisional application No. 61/513,591, filed on Jul. 31, 2011.

(51) Int. Cl. G06F 17/30

(52) U.S. Cl. CPC G06F 17/30241
USPC 707/724

(57) ABSTRACT

Geotagging is the process of adding geographical identification metadata to photographs and is a form of geospatial metadata. The current invention presents a method for determining the popularity/attractiveness of certain geographical areas by calculating the densities of the available photographs (or availability of photographs) with geodata corresponding to these geographical areas.

### FIELD OF THE INVENTION

Current invention is in the filed of processing geotagging or geodata of photographs.

### BACKGROUND OF THE INVENTION

Geotagging (also written as GeoTagging) is the process of adding geographical identification metadata to photographs and is a form of geospatial metadata. These data usually consist of latitude and longitude coordinates, though they can also include altitude, bearing, distance, accuracy data, and place names. It is commonly used for photographs, producing geotagged photographs.

Geotagging can help users find a wide variety of location-specific information. For instance, one can find images taken near a given location by entering latitude and longitude coordinates into a suitable image search engine. Geotagging-enabled information services can also potentially be used to find location-based news, websites, or other resources. Geotagging can tell users the location of the content of a given picture or other media or the point of view, and conversely on some media platforms show media relevant to a given location.

The related term geocoding refers to the process of taking non-coordinate based geographical identifiers, such as a street address, and finding associated geographic coordinates (or vice versa for reverse geocoding). Such techniques can be used together with geotagging to provide alternative search techniques.

### Geotagging Techniques

The base for geotagging is positions. The position will, in almost every case, be derived from the global positioning system, and based on a latitude/longitude-coordinate system that presents each location on the earth from 180° west through 180° east along the Equator and 90° north through 90° south along the prime meridian.

### Geotagging Photographs

There are two main options for geotagging photographs; capturing GPS information at the time the photo is taken or “attaching” the photograph to a map after the picture is taken.

To capture GPS data at the time the photograph is captured, the user must have a camera with built in GPS or a standalone GPS along with a digital camera. Because of the requirement for wireless service providers in United States to supply more precise location information for 911 calls by Sep. 11, 2012, more and more cell phones have built-in GPS chips. Some cell phones like the iPhone and Motorola Backflip already utilize a GPS chip along with built-in cameras to allow users to automatically geotag photographs. Others may have the GPS chip and camera but do not have internal software needed to embed the GPS information within the picture. A few digital cameras also have built-on or built-in GPS that allow for automatic geotagging such as Nikon, Sony and Ricoh. Devices use GPS, A-GPS or both. A-GPS can be faster getting an initial fix if you are within range of a cell phone tower, and may work better inside buildings. Traditional GPS does not need cell phone towers and uses standard GPS signals outside of urban areas. Traditional GPS tends to use more battery power. Almost any digital camera can be coupled with a stand alone GPS and post processed with photo mapping software such as GPS-Photo Link, Alta4, or EveryTrail to write the location information to the image's exif header.

Geographic coordinates can also be added to a photograph after the photograph is taken by “attaching” the photograph to a map using programs such as Flickr and Panoramio. These programs can then write the latitude and longitude into the photographs exif header after you have selected the location on a map.

### GPS Formats

GPS coordinates may be represented in text in a number of ways, with more or fewer decimals:

| Template | Description | Example |
|---|---|---|
| [−]d.d, [−]d.d | Decimal degrees with | 2.3456, −98.7654 |
| | negative numbers for | |
| | South and West. | |
| d° m.m′ {N\|S}, | Degrees and decimal | 12° 20.736′ N, |
| | minutes with N, S, E | |
| d° m.m′ {E\|W} | or W suffix for North, | 98° 45.924′ W |
| | South, East, West | |
| {N\|S} d° m.m′ | Degrees and decimal | N 12° 20.736′, |
| | minutes with N, S, E | |
| {E\|W} d° m.m′ | or W prefix for North, | W 98° 45.924′ |
| | South, East, West | |
| d° m′ s″ {N\|S}, | Degrees, minutes and | 12° 20′ 44″ N, |
| | seconds with N, S, E | |
| d° m′ s″ {E\|W} | or W suffix for North, | 98° 45′ 55″ W |
| | South, East, West | |
| {N\|S} d° m′ s″, | Degrees, minutes and | N 12° 20′ 44″, |
| | seconds with N, S, E | |
| {E\|W} d° m′ s″ | or W prefix for North, | W 98° 45′ 55″ |
| | South, East, West | |

With photographs stored in JPEG file format, the geotag information is typically embedded in the metadata (stored in Exchangeable image file format (EXIF) or Extensible Metadata Platform (XMP) format). These data are not visible in the picture itself but are read and written by special programs and most digital cameras and modern scanners. Latitude and longitude are stored in units of degrees with decimals. This geotag information can be read by many programs, such as the cross-platform open source ExitTool. Example readout for a photo might look like:

### GPS Latitude: 57 deg 38′ 56.83″ N

### GPS Longitude: 10 deg 24′ 26.79″ E

### GPS Position: 57 deg 38′ 56.83″ N, 10 deg 24′ 26.79″ E

The same coordinates could also be presented as decimal degrees:

### GPSLatitude: 57.64911

### GPSLongitude: 10.40744

### GPSPosition: 57.64911 10.40744

When stored in EXIF, the coordinates are represented as a series of rational numbers in the GPS sub-IFD.

When stored in EXIF, the coordinates are represented as a series of rational numbers in the GPS sub-IFD. Here is a hexadecimal dump of the relevant section of the EXIF metadata (with big-endianbyte order

| + [GPS directory with 5 entries] | |
|---|---|
| \| 0) | GPSVersionID = 2 2 0 0 |
| \| | - Tag 0x0000 (4 bytes, int8u[4]): |
| \| | dump: 02 02 00 00 |
| \| 1) | GPSLatitudeRef = N |
| \| | - Tag 0x0001 (2 bytes, string[2]): |
| \| | dump: 4e 00 [ASCII “N\0”] |
| \| 2) | GPSLatitude = 57 38 56.83 (57/1 38/1 5683/100) |
| \| | - Tag 0x0002 (24 bytes, rational64u[3]): |
| \| | dump: 00 00 00 39 00 00 00 01 00 00 00 26 00 00 00 01 |
| \| | dump: 00 00 16 33 00 00 00 64 |
| \| 3) | GPSLongitudeRef = W |
| \| | - Tag 0x0003 (2 bytes, string[2]): |
| \| | dump: 57 00 [ASCII “W\0”] |
| \| 4) | GPSLongitude = 10 24 26.79 (10/1 24/1 2679/100) |
| \| | - Tag 0x0004 (24 bytes, rational64u[3]): |
| \| | dump: 00 00 00 0a 00 00 00 01 00 00 00 18 00 00 00 01 |
| \| | dump: 00 00 0a 77 00 00 00 64 |

### Geotagging in Tag-Based Systems

No industry standards exist, however there are a variety of techniques for adding geographical identification metadata to a photo. One convention, established by the website Geobloggers and used by more and more sites, e.g. photo sharing sites Panoramio and Flickr, enables content to be found via a location search. All sites allow users to add metadata to a photo via a set of so-called machine tags (see folksonomy.

geotagged
geo:lat=57.64911
geo:lon=10.40744

This describes the geographic coordinates of a particular location in terms of latitude (geo:lat) and longitude (geo:lon). These are expressed in decimal degrees in the WGS84 datum, which has become something of a default geodetic datum with the advent of GPS.

Using three tags works within the constraint of having tags that can only be single ‘words’. Identifying geotagged information resources on sites like Flickr is done by searching for the ‘geotagged’ tag, since the tags beginning ‘geo:lat=’ and ‘geo:lon=’ are necessarily very variable.

Another option is to tag with a Geohash:

geo:hash=u4pruydqqvj

A further convention proposed by FlickrFly adds tags to specify the suggested viewing angle and range when the geotagged location is viewed in Google Earth:

ge:head=225.00
ge:tilt=45.00
ge:range=560.00

These three tags would indicate that the camera is pointed heading 225° (south west), has a 45° tilt and is 560 meters from the subject.

Where the above methods are in use, their coordinates may differ from those specified by the photo's internal EXIF data, for example because of a correction or a difference between the camera's location and the subject's.

### Uses of Geotagging

The most common use of geotagging of photographs is indexing and retrieval. This application enables a user to search and retrieve photographs according to their geodata. As far as we know, no application tries to apply statistical methods, such as counting, averaging, statistical testing, etc., on the geodata of samples of photographs for the purpose of discovering the popularity of certain geographical positions/area.

### BRIEF SUMMARY OF THE INVENTION

The current patent application presents a method for determining the popularity or attractiveness of certain geographical areas by calculating the densities of the available photographs (or availability of photographs) with geodata corresponding to these geographical areas.

This popularity or attractiveness can be presented in different ways, including, but not limited to a topographic map where the high of the landscape corresponds to it popularity, as a table where certain points of interest are presented with their corresponding popularity, etc. This popularity or attractiveness can be used in different applications including, but not limited to assisting tourists is determining geographical area, landmarks, or routes to visit, assisting business people in determining the viability of business projects, assisting scientists in determining in social attitudes, etc.

### DESCRIPTION OF THE DRAWINGS

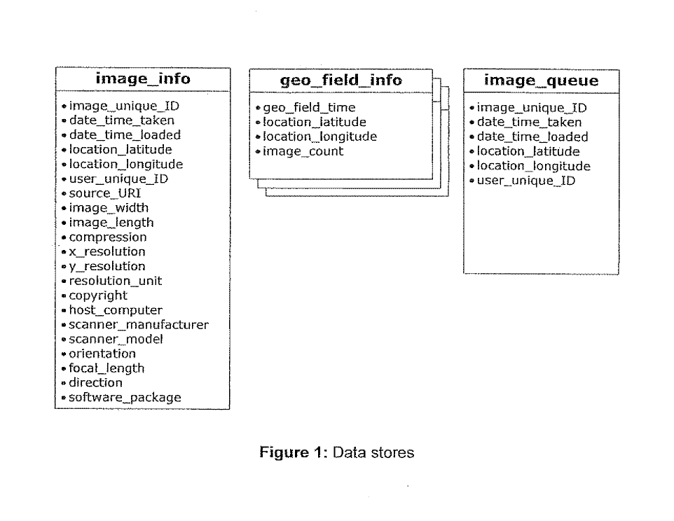

FIG. 1: Data-stores.

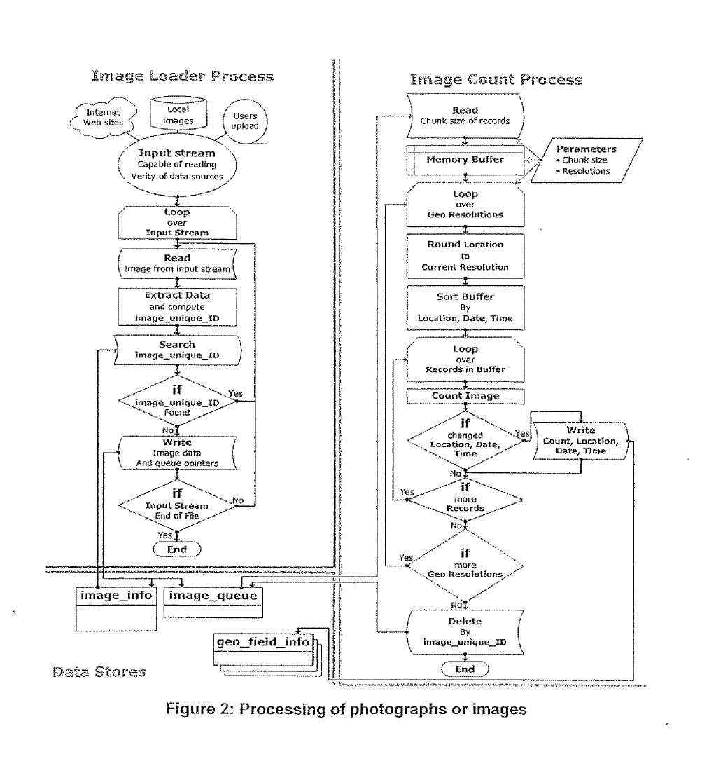

FIG. 2: System photographs or images processing flow chart of a one preferred method that uses geodata in a sample of photographs in determining the popularity or attractiveness of geographical areas.

### DETAILED DESCRIPTION OF THE INVENTION

Today there is a vast accumulation of photographs or images of landmarks stored in many private and public databases. These photographs or images originate from many people and organization, professionals, and non-professionals. The basic premise of the proposed invention is that the density of these photographs or images is indicative of the interest people have in these landmarks, of their popularity, or their attractiveness. In simple terms, the higher the number of these photographs or images in a given database, the higher is the popularity or attractiveness of the location associated with these photographs or images.

The current invention presents a method for determining the popularity or attractiveness of a certain geographical area by calculating the density of the available photographs or images associated with this geographical area.

In one preferred embodiment, the method collects all the available photographs or images in a database according to the latitude and longitude in the geodata of these photographs or images, and as these photographs or images apply to a certain predetermined geographical area. Then the method calculates the density of the available photographs or images associated with this geographical area by counting these photographs or images and normalizing the result to achieve a scaled ranking.

Check that all concepts are operationally defined
Check for “may” and “will”
Check FIG. 2 for inconsistencies

### General

The following sections describe the process of creating a database populated with the densities of photographs of images per geographic area. The description presents one preferred embodiment that includes a specific data processing method and an explicit database structure.

### Database Structure

Three major data stores are presented in the following figure:

image_info

The image_info data store includes an array of variables for every photograph or image. The variables include the geo data and other variables on these photographs or images. The data store includes one array for every photograph or image loaded into system. The variables in this data store are extracted directly from the meta tags of the photographs or images.

To provide an accurate density, it is important to count an image only once. For this reason, an identifier is added to the array. The identifier is called “image_unique_ID.” The identifier is the digest of the image data. A CRC64 algorithm is used. This algorithm is fast to compute, and provides uniqueness among 10¹⁹ different possibilities. When an image is loaded to the system, the loading process computes the “image_unique_ID,” and uses the identifier to search the “image_info” data store to ensure that the same image was not already processed.

geo_field_info

The “geo_field_info” data store includes an array of variables for every geographical field. The variables include the “location_latitude,” “location_longitude,” date_taken,” “image_count,”.

### Definition:

The geographic-field is area in the shape of a “square” where the “location_latitude” and “location_longitude” point to its North West edge. Each square has the same width and length measured in degrees (geographic measures latitude, longitude, width and length are all in decimal degrees as in WGS 84 GPS standers). In the current embodiment, the following concepts: geographical area, location, landscape, landmark, etc, are represented by the geographical-field concept.

The system populates several “geo_field_info” data stores, each calculated for a different geographical resolution. Different geographical resolutions are defined as squares with different sides length, in degrees: 10^{-6°}, 10^{-5°}, 10^{-4°} . . . 1°, or in meters: 1.1 m×1.1 m, 11.1 m×11.1 m, 111.1 m×111.1 m, . . . 111.1 Km×111.1 Km. These squares represent different resolutions of the geographical fields.

### Definition:

The time resolution is a time interval that measured in years, months, day of month, day of week, and hour either subsequently or separated.

The system will use the following time resolution intervals:
1) year,
2) year & month,
3) year & month & day of month,
4) year & month & day of week,
5) year & month & hour

Note that the “geo_field_info” data stores are per geographical resolution and per time resolution.

image_queue

The data store includes pointers to new images loaded into system. Images in the data store are deleted after they have been processed by the counting algorithm.

The purpose of this data store is to allow processing of new photographs or images without having to process the entire collection of photographs or images stored in the system. The reason for the additive processing is efficiency. Since, a large number of photographs or images are stored in system at, any given time, and because that number continues to grow, this data store eliminates the need for reprocessing of the entire set of photographs or images already in the system. This data store holds all necessary variables to implement the counting algorithm (see below: Image Count Process). It prevents unnecessary access to the “image_info” data store, while executing the counting algorithm.

### Data Processing

The processing of photographs or images is divided into two steps. The two steps allow efficient processing of a large number of photographs or images, and allow a flexible design.

The following figure illustrates the two stages.

### Introduction

This process imports the information stored in photographs or image files. The photographs or images themselves are not stored in the system.

There are several possible processes for importing this information into the system. Consider the following example. In this example there are different sources of photographs or images, and a number of photographs or images in every source. This process uses a stream capable of reading data from various sources, such as FTP, HTTP, or FILES stream. An example of such a stream is the cURL library.

### The Process

| | |
|---|---|
| 1. | Open stream |

In certain embodiments, the URL of the source is supplied as
argument to the process.

| | |
|---|---|
| 2. | Loop over images |

At certain times, this operation requires parsing of XML content
(or other data formats) to generate a list of photographs or images
available at the source.

| a. | Load an image into memory |
|---|---|
| Using a stream, the process creates the URL of every | |
| photograph or mage file, opens it, and loads the photograph or | |
| image into memory, including its meta tags. | |
| b. | Extract Data and compute “image_unique_ID” |

| | |
|---|---|
| i. | The process parses the photographs or image |
| | according to its file type (jpg, png, bmp, tif, raw . . . ). |
| ii. | The process extracts all needed information in |
| | compliance with the “image_info” |
| | record fields. |
| iii. | The process computes “image_unique_ID” by |
| | calculating CRC64 digest from RGB parts of the |
| | photograph or image. |

| | |
|---|---|
| c. | If |

```
  The process tests if the photograph or image was already
  processedusing the “image_unique_ID” in the
  “image_info” data store.
  If the “image_unique_ID” is not found, then,
```

| | |
|---|---|
| i. | The process prepares and writes the “image_info” |
| | variables |
| ii. | The process prepares and writes “image_queue” |
| | variables (note that the variables in the |
| | “image_queue” data store are a subset of the variables in |
| | the “image_info” data store). |

| | |
|---|---|
| d. | End If |

| | |
|---|---|
| 3. | End Loop |
| 4. | Close stream |
| 5. | Exit |

### Image Count Process

### Introduction

This process builds and updates the “geo_field_info” data store. The process counts the number of images per a geographical-field and per time-field. The system produces several “geo_field_info” data stores, each for different resolution.

### The Process

| 1. | Read images | |
|---|---|---|
| | The process includes a loop of reading variables from | |
| | “image_queue” data store | |
| | into a memory storage buffer. | |
| 2. | Loop over geographic resolutions | |
| | The process loops through different levels of resolutions. It | |
| | starts at the resolution of 10⁻⁶ degrees and | |
| | progresses to the resolution of 1 degree. | |
| | “geo_resolution” is fraction, such as: 10⁻⁶, 10⁻⁵, | |
| | 10⁻⁴, . . . 1 that represent the resolution | |
| | that is the current index of loop. | |
| | a. | Loop over time resolutions |
| | | This step is an inner loop of the above loop. The loop |
| | | iterates from 1 to 5. The index of this loop is called |
| | | time_resolution. |

| | |
|---|---|
| i. | Round location and time to current resolutions |
| | This step is an inner loop of the above loop. |
| | The loop iterates over all images in the buffer, |
| | and aligns the location and time variables. |
| | Align of “location_latitude” and |
| | “location_longitude” is done by |
| | using the following formula: |
| | location = integer( location / geo_resolution ) * |
| | geo_resolution |
| | “location” represents “location_latitude” |
| | and “location_longitude,” |
| | the formula is used to calculate both variables. |
| | Align of “geo_field_time” to the |
| | time_resolution. This is done by using a function |
| | named “get_geo_field_time” |
| | using following formula: |
| | switch ( time_resolution ) |
| | 1: geo_field_time = date_taken.year |
| | 2: geo_field_time = date_taken.year * 100 + |
| | date_taken.month |
| | 3: geo_field_time = date_taken.year*10000 + |
| | date_taken.month*100 + date_taken.day_of_month |
| | 4: geo_field_time = date_taken.year*10000 + |
| | date_taken.month*100 + date_taken.day_of_week |
| | 5: geo_field_time = date_taken.year*10000 + |
| | date_taken.month*100 + date_taken.houre |
| ii. | Sort buffer |
| | This operation sorts the buffer by “location_latitude,” |
| | “location_longitude,” and “geo_field_time.” |
| iii. | Initialize |
| | Set count = 0 |
| | Set lat = location_latitude [first_row] |
| | Set lon = location_longitude [first_row] |
| | Set day = get_geo_field_time( date_time_taken |
| | [first_row] ) |
| iv. | Loop over images in buffer |
| | This operation iterates over all photographs or images |
| | in the buffer for counting and writing. |

| | |
|---|---|
| 1. | Increment |
| | count = count + 1 |
| 2. | If |
| | lat not-equal location_latitude [current_row] or |
| | lon not-equal location_longitude [current_row] or |
| | day not-equal geo_field_time [current_row] |

| | |
|---|---|
| a. | Write “geo_field_info” variables in |
| | data store for current resolution |
| | This operation writes a “geo_field_info” |
| | using: lat, lon, day, and count |
| | Note: if a record already exists, the record is |
| | updated as: image_count = image_count + |
| | count |
| b. | Initialize |
| | count = 0 |
| | lat = location_latitude [current_row] |
| | lon = location_longitude [current_row] |
| | day = get_geo_field_time( date_time_taken |
| | [current_row] ) |

| | |
|---|---|
| 3. | End If |

| | |
|---|---|
| v. | End Loop |

| | |
|---|---|
| b. | End Loop |

| | |
|---|---|
| 3. | End Loop |
| 4. | Delete process_queue |
| | This operation is a loop that deletes variables from |
| | “image_process_queue” |
| | data store. |
| 5. | Exit |

Note that the method of the current invention does not process the content of the photographs. In other words, this method does not use graphical processing methods. Consider the main difference between the method in the current invention and standard graphical processing methods, such as facial recognition methods. According to these methods, two photographs that present the same object (landscape), but have different geodata, that is, were taken from different locations or angles, are considered the same photographs. In contrast, these photographs are considered as different by the current invention. According to the current invention, two photographs taken from the same geographical position, but record the landscape in opposite directions, are considered the same photograph. In contrast, the standard graphical processing methods, consider these photographs as different.

The current invention can be used in many applications. For instance, a user can use the ranking to select his most preferred landmarks to visit. Another user can use the ranking to determine his most preferred location to start a certain business. Another user can use the ranking to determine his most preferred routes when visiting a certain area. Yet another user can use the ranking to determine his time allocation, best timing, etc. when visiting a certain area.

When people like a sight or have a good-time, they often take a picture. In recent years, the preferred way to take those pictures is the built-in cameras in cellular phones. Equipped with GPS, and new location discovery technologies, the cellular phones add location, date, angle, and more information to the picture. Millions of such pictures are uploaded to interne sites for public viewing.

Web sites like “Google Earth” have millions of such pictures. An inspection of these websites shows that some locations have more pictures than others. There are locations where in the same square meter there are more than 100 pictures.

The current invention presents a database that stores the density of such pictures per geographic location. One possible interpretation of such densities is the popularity of these locations. This database is more accurate than other solutions that are based on people recommendations, because the pictures are taken to stimulate memory. They are immediate. They preserve an impression, and they do not require additional skills, such as writing reviews (which is done later). The density in the current invention is based on more participants then other solutions (larger sample size, unbiased). Because of the simplicity of taking pictures, many people are using web based solution to store pictures in many events (like group trips, sports, family events, and more).

In one preferred embodiment, the statistical analysis of the photographs is done by counting the amount the number of pictures in given area. It does not require lexical analysis, or image analysis of the photographs. In addition, the preferred embodiment is analyzing the timestamp of the photo to derive conclusions about visiting time, date, season, frequency, availability, accessibility, etc. of certain given areas.

What we claim is:

1. A method for calculating the number of photographs, wherein all photographs comprise geodata corresponding to a predefined geographical area.

2. The method in claim 1, where said method is used for determining the popularity or attractiveness of said geographical area.

3. The method in claim 1, where said method is used for producing a ranking of said geographical area.

4. A method comprising the following steps:
a. Selecting a geographical area identified by the area's geodata.
b. Selecting a database that comprises photographs, wherein some photographs comprise geodata.
c. Collecting a random sample of said photographs from said database with geodata corresponding to said area.
d. Calculating the number of said photographs in said sample.

5. The method in claim 4, where said sample includes all photographs in the database.
